(19) United States
(12) Patent Application Publication
(10) Pub. No.: US 2005/0275982 A1
(43) Pub. Date: Dec. 15, 2005

(54) Lamp holder with ground fault circuit interrupter receptacle

(76) Inventors: Steve Campolo, Malverne, NY (US); Lawrence S. Leopold, Floral Park, NY (US); James Richter, Bethpage, NY (US); James A. Porter, Farmingdale, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/093,211

(22) Filed: Mar. 30, 2005

Related U.S. Application Data
(60) Provisional application No. 60/559,912, filed on Apr. 6, 2004.

(51) Int. Cl. H02H 3/00

(52) U.S. Cl. 361/42

(57) ABSTRACT

A lamp holder has provisions for mounting a lamp socket and a ground fault circuit interrupter (GFCI) receptacle. The lamp holder includes an opening sized to accommodate the GFCI and at least one opening sized to accommodate the lamp socket. The lamp holder can be mounted to a standard outlet box and can have a provision to accommodate a lamp socket having a pull-chain switch.

This application claims the benefit of the filing date of a provisional application having Ser. No. 60/559,912 which was filed on Apr. 6, 2004.

### BACKGROUND

1. Field of the Invention

The present invention relates to a ground fault current interrupter (GFCI) and lamp holder.

2. Description of the Related Art

A ground fault is an unintentional electric path between a source of current and a grounded surface. Ground faults can occur when current is leaking or escaping to an electrical ground. If a person's body provides a path to the ground for this leakage, the person could be injured, burned, shocked, or electrocuted.

In the home's wiring system, a GFCI can monitor electric current flowing to a load and sense any loss of current. When the current flowing to the load differs by a pre-selected amount from that returning, the GFCI can interrupt power to that load. The GFCI can be designed to interrupt the power to help prevent injury to a person.

A GFCI receptacle may be used in place of a standard duplex receptacle found throughout most homes and businesses. The GFCI can protect against ground faults to an electrical load plugged into the outlet. Many receptacle-type GFCls also can be installed to provided ground fault protection to other electrical outlets and loads further “down stream” in a branch circuit.

GFCI protection can be required for many locations including most outdoor receptacles, bathroom receptacle circuits, garage wall outlets, kitchen receptacles, and receptacles in crawl spaces and unfinished basements. Some locations where GFCIs are located also may be less finished than other locations in a house. These locations may not have extensive wiring and switches for lighting as may be prevalent in other more finished locations.

### SUMMARY OF THE INVENTION

A lamp holder has provisions for mounting a lamp socket and a ground fault circuit interrupter (GFCI) receptacle. The lamp holder includes an opening sized to accommodate the GFCI receptacle and at least one opening sized to accommodate the lamp socket. The opening for the lamp socket can be sized to accept a socket for a standard lamp including an incandescent lamp.

Some implementations of the disclosure have the advantage that a single installation can satisfy the need for illumination and GFCI protection in areas where a single installation is required or convenient including a basement, kitchen, bathroom, garage, crawlspace or exterior receptacle outlet accessible from grade level.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest terms.

### BRIEF DESCRIPTION OF THE DRAWINGS

Other aspects, features and advantages of the present invention will become more apparent from the following detailed description, the appended claims and the accompanying drawings in which similar elements are given similar reference numerals.

FIG. 1 illustrates a top perspective view of a first embodiment of holder for receiving a GFCI and a lamp;

FIG. 2A illustrates a top perspective view of the GFCI and lamp holder of FIG. 1 showing wiring devices mounted in the lamp holder;

FIG. 2B illustrates a bottom perspective view of the GFCI and lamp holder of FIG. 1 showing electrical components mounted in the lamp holder; and

FIG. 3 illustrates a top perspective view of another embodiment of a holder for a GFCI and two lamps.

### DETAILED DESCRIPTION OF THE INVENTION

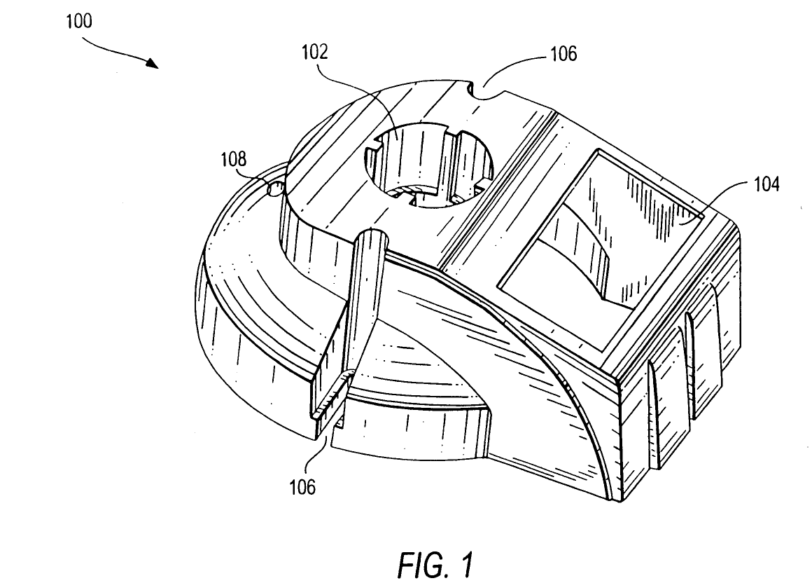

FIG. 1 is a top perspective view of a first embodiment of a lamp holder 100 in accordance with the present disclosure. The lamp holder 100 can have openings to receive a lamp socket 102 and a ground fault circuit interrupter (GFCI) receptacle 104. The lamp socket opening can be sized to receive a lamp socket that can accommodate various kinds of lamps including incandescent and fluorescent having an incandescent base. The GFCI receptacle opening may have one or more receptacle mounting holes (not shown) to enable mounting of the GFCI receptacle to the lamp holder. The receptacle mounting holes can be threaded to receive a screw used to mount the receptacle to the lamp holder. The lamp holder also can include one or more mounting portions 104 positioned to enable mounting of the lamp holder to a standard outlet box. The lamp holder may be mounted to the outlet box using screws inserted through mounting portions of the lamp holder and threaded into threaded portions of the outlet box. In an implementation, the lamp holder 100 can include an opening 108 to accommodate an electrical switch. The switch (not shown) can be used to control the delivery of power to the lamp socket and receptacle. Alternatively, the lamp socket can include a standard pull chain switch to control delivery of power to the lamp socket. In another implementation, the lamp holder can accommodate a standard electrical receptacle.

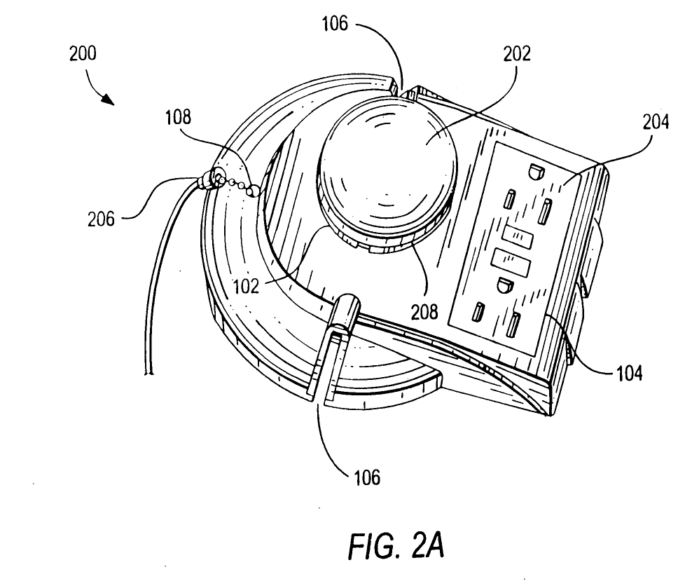

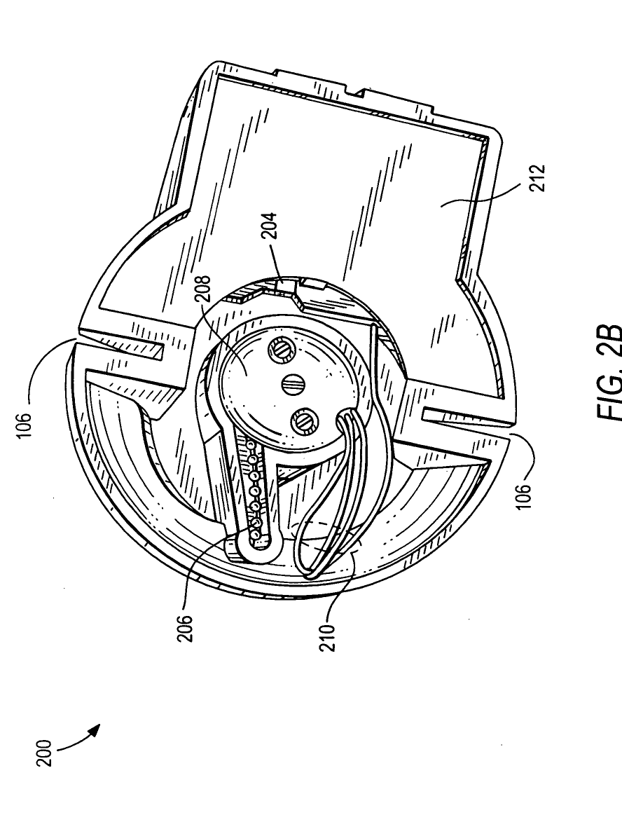

FIG. 2A illustrates a front perspective of the lamp holder 200 of FIG. 1 including a pull-chain switch 206, a lamp socket and a GFCI. FIG. 2B illustrates a rear perspective of the lamp holder 200 of FIG. 1. A lamp socket 208 can be mounted in the lamp socket opening 102 and a GFCI receptacle 204 mounted in the receptacle opening 104. Electrical wiring is generally shown as 210. Power from a household branch circuit can be wired to the GFCI receptacle 204. The GFCI receptacle also can be wired to monitor the leakage current to the lamp socket 208 and downstream loads (not shown). Alternatively, the power may be supplied to the lamp socket 208 independently of the GFCI receptacle 204. The lamp socket 208 may have a pull-chain switch 206 to control power from the lamp socket 208 to an installed lamp 202 (not part of the invention). A back cover 212 made of an insulating material, such as plastic, can cover selected portions of the back of the lamp holder. The back cover 212 can provide protection for wiring and electrical connections in portions of the lamp holder that extend past an outlet box (not shown) mounted in the wall. In an implementation, a separate switch may be installed in the switch opening 108. The switch can be wired in series with the power from the household branch circuit to control power to the GFCI receptacle and/or lamp socket. Once the wiring is completed, the lamp holder 200 can be mounted to an outlet box by screws inserted through the mounting portions 106 and threaded into the outlet box.

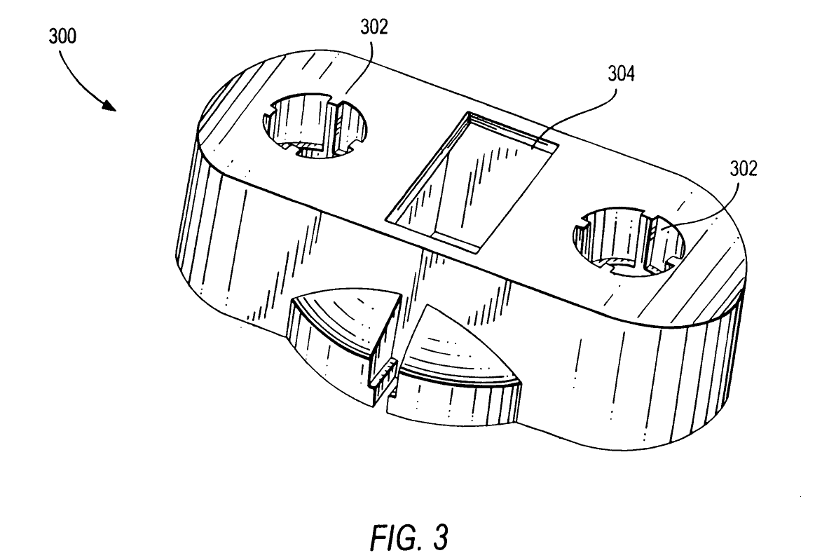

FIG. 3 is top perspective view of another embodiment of a lamp holder 300 in accordance with the present disclosure. The lamp holder 300 can have openings to receive two lamp sockets 302 and a ground fault circuit interrupter (GFCI) receptacle 304. The GFCI receptacle opening 304 can be positioned between the lamp socket openings 302. The lamp holder may include an opening for a switch (not shown) as described above. The lamp sockets mounted in the lamp socket openings 302 can include a pull-chain switch. In an implementation, a separate switch (not shown) may be mounted in the switch opening to control flow of power to the lamp socket and/or GFCI receptacle.

While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

1. A lamp holder comprising:
a first opening to accommodate a ground fault circuit interrupter receptacle; and
a second opening to accommodate a first lamp socket.

2. The lamp holder of claim 1, wherein the first opening is rectangular and the second opening is circular.

3. The lamp holder of claim 1, wherein the lamp socket includes a pull-chain switch.

4. The lamp holder of claim 1 comprising a third opening to accommodate a second lamp socket.

5. The lamp holder of claim 4, wherein the first opening is located between the second and third openings.

6. An outlet box lamp holder comprising:
an enclosure adapted to mount to an outlet box;
a first lamp socket mounted in the enclosure; and
a ground fault circuit interrupter receptacle mounted in the enclosure.

7. The outlet box lamp holder of claim 6 comprising a second lamp socket mounted in the enclosure.

8. The outlet box lamp holder of claim 7, wherein the ground fault circuit interrupter is positioned between the first and second lamp sockets.

9. The lamp holder of claim 6, wherein at least the first lamp socket includes a pull-chain switch.

10. The lamp holder of claim 1 further comprising an occupancy sensor adapted to control delivery of power to the first lamp socket.

11. The lamp holder of claim 1 further comprising a photoelectric sensor adapted to control delivery of power to the first lamp socket.

12. The lamp holder of claim 6 further comprising an occupancy sensor adapted to control delivery of power to the first lamp socket.

13. The lamp holder of claim 6 further comprising a photoelectric sensor adapted to control delivery of power to the first lamp socket.
